(19) United States
(12) Patent Application Publication
(10) Pub. No.: US 2007/0186242 A1
(43) Pub. Date: Aug. 9, 2007

(54) Personal content recorder suggestion and subscription

(76) Inventors: James D. Price III, Foothill Ranch, CA (US); Franklyn S. Nelson, Alameda, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/346,784

(22) Filed: Feb. 3, 2006

(51) Int. Cl. H04N 5/445; G06F 3/00; G06F 13/00

(52) U.S. Cl. 725/46; 725/58; 725/45

(57) ABSTRACT

An advantageous system, apparatus, and method for publishing and subscribing to viewer supplied suggestions for programming are provided allowing for personalized suggestions from individual sources. Advantageously, the present invention allows for the automated recording of favorite programming of friends, family, coworkers, peers, and select others.

### TECHNICAL FIELD

The present invention relates generally to content programming and, more particularly, to a system, apparatus, and method for suggesting programming to be recorded.

### BACKGROUND

In recent years, intelligent video recording devices and related services provided by service providers have become a common way for users to timeshift the programs that they would like to watch on television, cable, satellite, broadband Internet, or other video viewing means. These devices are commonly called personal video recorders (PVRs), digital video recorders (DVRs), and by product names such as TiVo® and ReplayTV®. Examples of such devices are described in U.S. Pat. Nos. 6,233,389, 6,324,338, and 6,868,225, the full disclosures of which are incorporated by reference herein for all purposes.

As these devices have expanded in their capabilities, many of them have become networked to allow remote scheduling of programming by users of the timeshifting service. Some devices have “intelligent” suggestion engines, which monitor the content of the shows that a user records on their device, and records similar programming that the user may enjoy (e.g., TiVo offers such a service). These suggestions may be done by examining the aggregate viewer patterns and by applying a suggestion algorithm to recommend additional programming. Although these suggestion engines add programming that is of interest to an aggregate of users with similar tastes, they lack the ability to suggest programming based upon the interests of friends, family, coworkers, and peers. Timeshifting of other content such as podcasts and Internet radio programs, is also possible and similar issues arise.

Thus, a means and method for suggesting content based upon the viewing/listening patterns of others is highly desirable to give the customer more choice and options in programming.

### BRIEF DESCRIPTION OF THE DRAWINGS

FIG. 1 shows a system for publishing a personal list of suggested programming and subscribing to such a list.

FIG. 2 shows a flowchart of a method for publishing a list of suggested programming in accordance with an embodiment of the present invention.

FIG. 3 shows a flowchart of a method for subscribing to a list of suggested programming in accordance with an embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

The present invention provides an advantageous system, apparatus, and method for publishing and subscribing to viewer supplied suggestions for programming allowing for personalized suggestions from individual sources. “Programming”, “suggested programming”, or variations thereof is defined in this document as a description of content that has been recorded or is scheduled to be recorded by a recording device. The description of content (e.g., a title, an actor name, and/or a genre) may vary from specific to general. A “list of programming”, a “list of suggested programming”, or variations thereof is defined in this document as a list of descriptions of content that has been recorded or is scheduled to be recorded by a recording device. Advantageously, the present invention allows for the automated recording of favorite programming of friends, family, coworkers, peers, and select others. Various types of content may be programmed and then listed, including but not limited to broadcast video and network delivered content such as podcasts and Internet radio.

In accordance with an embodiment of the present invention, one may subscribe to a user's “hotlist” including a number of the user's favorite programs. Rather than getting generic suggestions from a timeshifting service as typically done, a user may subscribe to specific published lists of programming recommendations/suggestions directly through individuals that they choose.

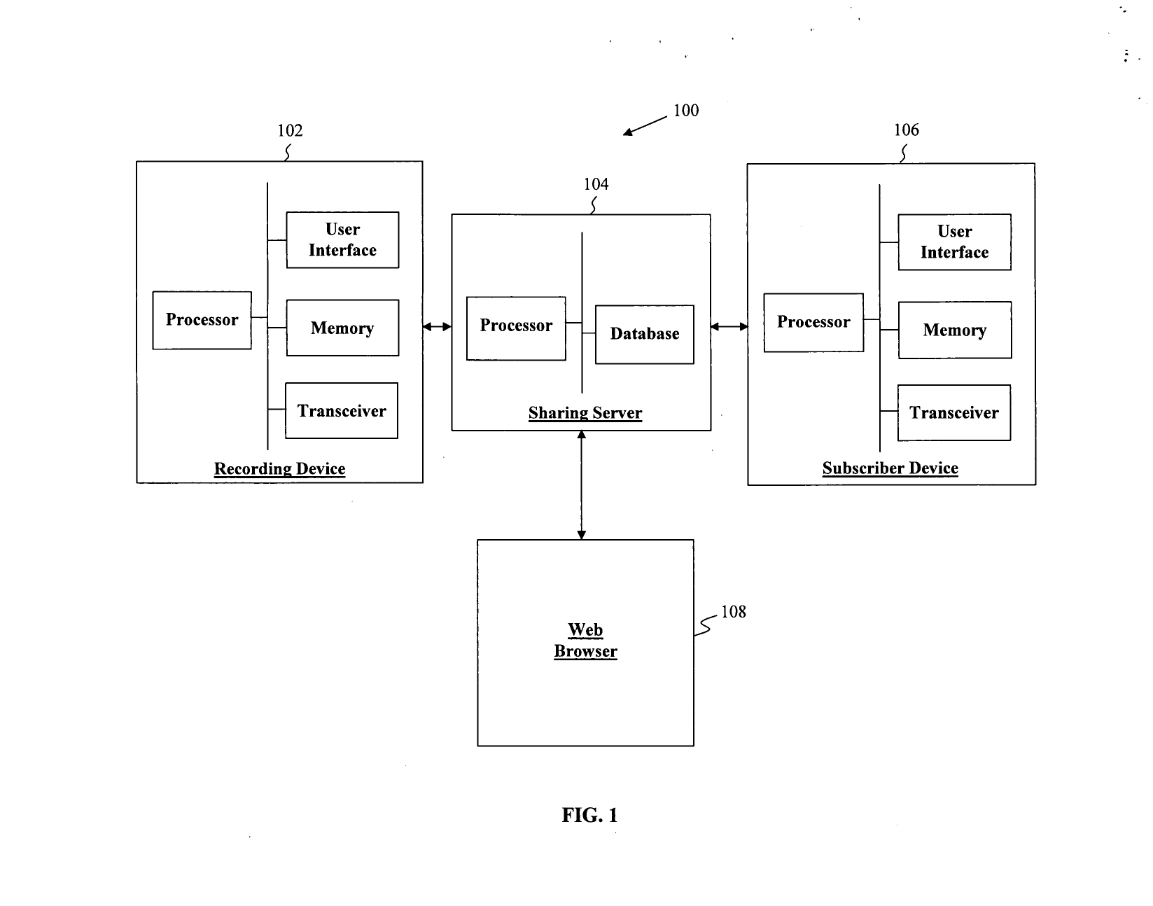

Referring now to FIG. 1, a system 100 for publishing and subscribing to personal suggestions for programming is shown. System 100 includes a recording device 102, a subscriber device 106, and a Web browser 108, all three of which are operably coupled to a sharing server 104.

Recording device 102 may be comprised of various recording apparatus, such as a PVR or a DVR, with a processor and user interface for providing a list of programmed content to a server for publication. The user interface may include a display, a keyboard, a real time clock, and a memory for storing data. Recording device 102 may also include a transceiver (a device that both transmits and receives/detects digital and/or analog signals) for detecting signals through a network wire and applying signals onto the network wire.

Subscriber device 106 includes a processor and user interface for receiving and searching published lists of programmed content from select users, and also allows for subscribing to selected content from the published lists. The user interface may include similar components to those described above with respect to the recording device 102.

Sharing server 104 includes a processor for receiving lists of programmed content, organizing the programmed content, and publishing the lists of programmed content. Sharing server 102 may also include a database for collecting, organizing, and searching through programming data. The database can either passively collect information received from recording device 102, collecting information when triggered by spontaneous user action or according to a schedule, or actively collect information through polling or discovery triggering.

Web browser 108 allows a user to select content for publication via the Internet and also allows a subscriber to select content for subscription via the Internet. In accordance with another embodiment of the present invention, recording device 102 and/or subscriber device 106 may be managed or controlled via the Web. In one embodiment, data may be accessed and files shared via Web browser 108. A user name and password may be required before access is allowed. Lists and apparatus or system settings may be added to or edited via the Web. Administrator rights may give access to system, user, and status settings and properties. Groups and shared folders may be added or existing properties edited via the Web. Reset to default and firmware upgrades may also be provided via the Web.

Accordingly, the present invention advantageously provides for remote management and maintenance of programming lists via the Internet.

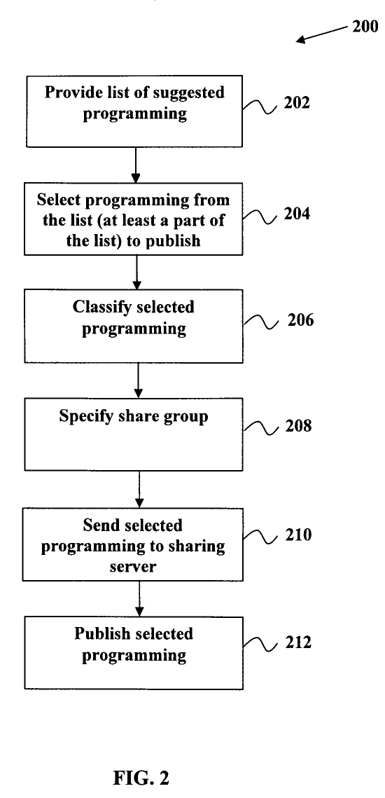

Referring now to FIG. 2 in conjunction with FIG. 1, a flowchart of a method 200 for publishing a content list is shown in accordance with an embodiment of the present invention.

At step 202, a list of suggested programming is provided via recording device 102 or server 104. At step 204, a user may choose to either publish all of their programming or selected parts of their programming via a user interface of recording device 102. Optionally, as shown at step 206, the user may define/classify and name subsets of their programming, allowing for greater flexibility and efficiency in sharing of their programming lists. Optionally, as shown at step 208, the user may also define and name “share groups”, which are collections of users or user types, and then specify to which share group to pose the programming list. The user choices may be made via a user interface of a video recording device (e.g., PVR or DVR) such as an on-screen menu, or via a remote method such as by using Web browser 108 to access a website of the service provider. At step 210, the programming selected for publication is sent to server 104, which organizes and stores the data, in one example via a database.

The recording device or service provider server hosting the provider's website then publishes the selected user list to the service provider's servers, as shown at step 212. This may be done at the same time that the device contacts the service provider to download regular programming information, and/or it may occur separately, for example at a scheduled or selected time interval or upon power-up of the recording device. The data transfer may be of an XML file of the selected program information to be published, or it may be any other applicable data type.

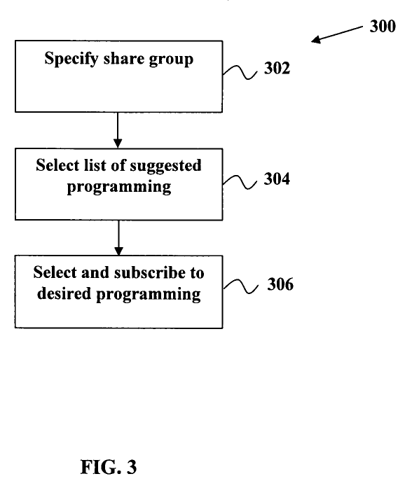

Referring now to FIG. 3 in conjunction with FIG. 1, a flowchart of a method 300 for subscribing to a list of suggested programming is shown in accordance with an embodiment of the present invention.

A subscribing user (“subscriber”) may enter the information of the selected suggestion feed through an on-screen user interface of subscriber device 106, or the subscriber may subscribe through a remote method such as by using Web browser 108 to access a website of the service provider. The subscriber may also subscribe to a suggestion feed on an information-only basis, where the suggestions are listed but not automatically recorded. In one example, as shown at steps 302, 304, and 306, the subscriber may specify various options to subscribe to programming posted to share groups of which the subscriber is a member, ranging from subscribing automatically to all programs on a selected list to individually selecting which programs from a list to add to their own programming lists.

Upon the subscriber device's connection to the service provider's server, the device will download the published suggestion data. The program information from the suggestion data may then be integrated into the device's recording schedule. Prioritization of the suggestions and conflict resolution with prior scheduled programming would be handled by the device's recording engine, with a variety of algorithms being within the scope of the present invention.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A recording device, comprising:
a processor configured to provide a list of suggested programming;
a user interface for selecting programming from the list to be published; and
a transmitter for transmitting the selected programming to a sharing server for publication.

2. The device of claim 1, wherein the user interface allows for classifying the suggested programming.

3. The device of claim 1, wherein the user interface allows for specifying a share group in which to publish the selected programming.

4. The device of claim 1, wherein the user interface allows for selecting programming from the list via a Web browser.

5. The device of claim 1, wherein the processor provides the list of suggested programming based upon connection to the sharing server, on a time schedule, or power up of the recording device.

6. A recording device, comprising:
means for providing a list of suggested programming;
means for selecting at least a part of the list to be published; and
means for transmitting the selected part of the list to a server for publication.

7. A subscriber device, comprising:
a processor configured to provide a list of suggested programming from a recording device;
a user interface for selecting programming from the list for subscription; and
a transmitter for transmitting the selected programming to a server for subscription.

8. The device of claim 7, wherein the user interface allows for selecting a classification of programming in which to search for a published list of suggested programming.

9. The device of claim 7, wherein the user interface allows for selecting a share group in which to search for a published list of suggested programming.

10. The device of claim 7, wherein the user interface allows for subscribing to suggested programming via a Web browser.

11. A subscriber device, comprising:
means for providing a list of suggested programming from a recording device;
means for choosing programming from the list for subscription; and
means for transmitting the choice of selected programming to a server for subscription.

12. A sharing server, comprising:
a receiver for receiving a list of suggested programming from a recording device;
a transmitter for sending the list of suggested programming to a subscriber processor; and
a processor for directing the flow of the list of suggested programming from the recording device to the subscriber processor.

13. The server of claim 12, wherein the processor is configured to classify the suggested programming.

14. The server of claim 12, wherein the processor is capable of organizing share groups for receiving the list of suggested programming.

15. The server of claim 12, wherein the processor is configured to publish the list of suggested programming for a subscriber to view.

16. The server of claim 12, wherein the processor is configured to receive instructions for publishing the list of suggested programming via a Web browser.

17. A method for managing personal lists of suggested programming, the method comprising:
providing a list of suggested programming from a recording device; and
sending the list of suggested programming to a subscriber processor.

18. The method of claim 17, further comprising classifying the suggested programming.

19. The method of claim 17, further comprising specifying a share group in which to publish the list of suggested programming.

20. The method of claim 17, further comprising publishing the list of suggested programming.
